(19) United States
(12) Patent Application Publication
(10) Pub. No.: US 2024/0124651 A1
(43) Pub. Date: Apr. 18, 2024

(54) THERMOSET MATERIALS OBTAINED FROM SPECIFIC PHTHALONITRILE RESINS FOR HIGH-TEMPERATURE APPLICATIONS

(71) Applicant: COMMISSARIAT À L'ÉNERGIE ATOMIQUE ET AUX ÉNERGIES ALTERNATIVES, Paris (FR)

(72) Inventors: Damien Brandt, Monts (FR); Nathanaël Chaussoy, Monts (FR); Jean-Francois Gerard, Monts (FR)

(21) Appl. No.: 18/256,503

(22) PCT Filed: Dec. 8, 2021
(86) PCT No.: PCT/FR2021/052245

§ 371 Date: Jun. 8, 2023

(30) Foreign Application Priority Data
Dec. 11, 2020 (FR) 2013068

(51) Int. Cl. C08G 73/08; C08K 3/04; C08K 7/06

(52) U.S. Cl. CPC C08G 73/08; C08K 3/04; C08K 7/06

(57) ABSTRACT

A thermoset material obtained from a curing by heat treatment of a resin that can be obtained by polycondensation, in basic medium, of at least one phthalonitrile compound bearing on its benzene ring at least one hydroxyl group.

### FIELD OF THE INVENTION

The present invention relates to thermoset materials obtained from the curing of specific phthalonitrile resins, specific phthalonitrile resins, composite materials and preparation methods thereof.

Conventional phenolic resins, also commonly known as phenoplast resins, result from the polycondensation of a phenolic compound (conventionally, phenol) with an aldehyde compound (conventionally, formaldehyde, also referred to as formol) accompanied by the formation of water molecules, this polycondensation resulting in oligomers or condensates comprising a chain of aromatic rings bonded together via methylene groups, these oligomers being capable of being subsequently converted by thermal polycondensation in the optional presence of a catalyst into a three-dimensional lattice, giving rise to a very strong cured material. Due to this strength, these materials can find an application in industries requiring the use of materials resistant to conditions of extreme temperature and friction (in particular, ablative materials), as is the case of the aerospace industry and particularly for the design of rocket nozzles, parts resistant to atmospheric re-entry, thermal protective coatings, in particular thermal shields. More specifically, these materials are conventionally used in the composition of composite materials, wherein they form the polymer matrix trapping the fillers, such as carbon fibres, glass fibres.

However, conventional phenolic resins, advantageously used before curing in resol form, further comprise free formaldehyde and phenol (i.e. not yet condensed). However, formaldehyde is a Category Ib carcinogenic, mutagenic or toxic for reproduction (CMR) compound, which from 2026, through the REACH regulation, will be included in Annex XIV, which means, in other words, the ban of the sale of all products comprising a formaldehyde content above 0.1%.

In addition, due to this CMR classification, from the future REACH regulation, there is a genuine need to provide phenolic resins or substitutes thereof having a reduced formaldehyde content or the total absence of formaldehyde, in particular to minimise or eliminate toxicity problems associated with this product, while having comparable or superior degradation properties.

By way of phenolic resin substitutes, phthalonitrile resins have been proposed which result from polycondensation of a phthalonitrile compound (i.e. a benzene compound having two nitrile groups at ortho position in relation to each other) by heat treatment and in the presence of an electrophilic catalyst (for example, a Bronsted acid or a Lewis acid) or a nucleophilic catalyst (for example, a phenolic compound, an aromatic amine compound), the nitrile groups reacting via polycondensation mechanisms to form isoindolines, triazines and phthalocyanines as described by Liu et al. (Polymer 2018, 143, 28-39) illustrated in the reaction scheme shown hereinafter:

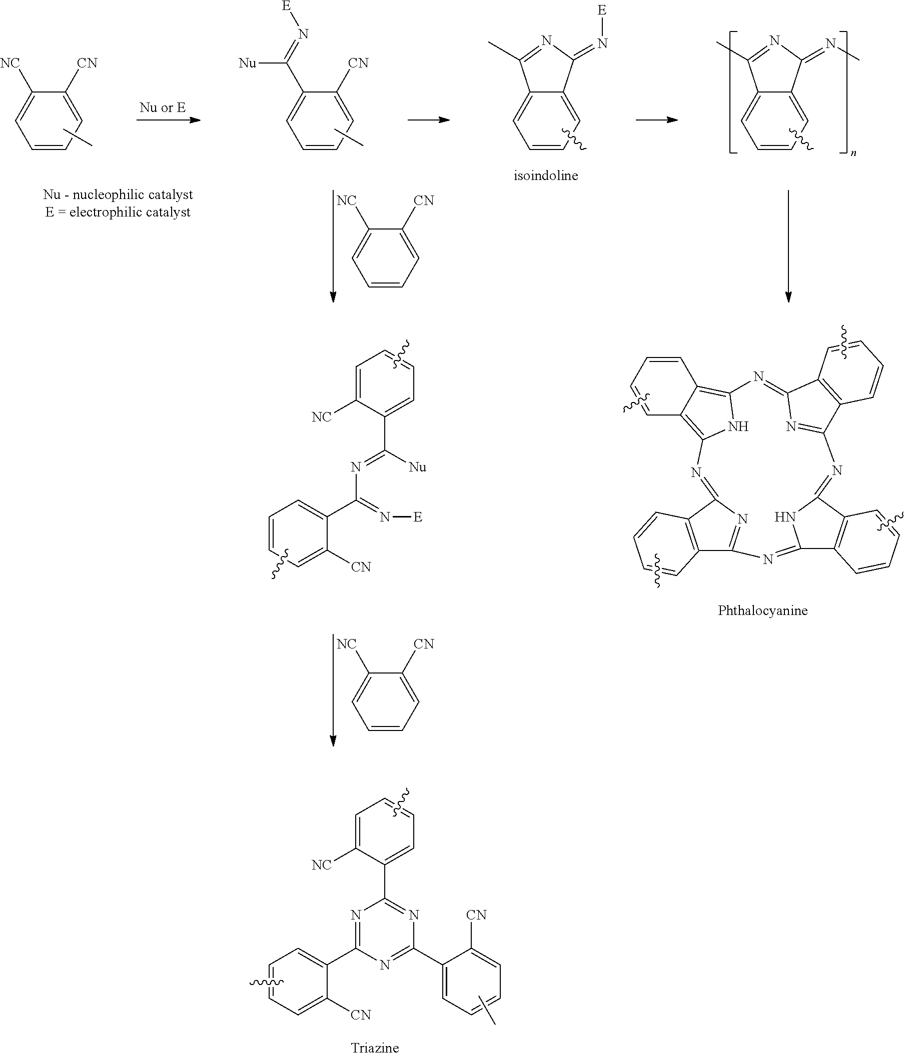

More specifically. two phthalonitrile resin generations have already emerged.

The first generation was synthesised from bisphenol salt (A, F, S, A6F, etc.) and 4-nitrophthalonitrile, the curing (orcrosslinking) of the resin being carried out in the presence of an aromatic diamine. However, these monomers have high melting points (185-230° C.) and a small window of processability, which limits the use thereof. For this reason, the second generation aimed to develop monomers with a low melting point with a broad window of use. For this, different strategies were adopted such as the incorporation of ether bonds, the introduction of ball-and-socket joints or the use of more complex monomers, as described in US 2017/0002146. This research led, in particular, to the development of a specific resin: “PEEK-like phthalonitrile”. However, the monomer used for the synthesis of this resin has a melting point around 200° C., correlated with the need to add a diamine which will inevitably induce the formation of porosity in the polymer and finally lengthy and high-temperature curing times (up to 400° C.).

In addition, the key of the development of phthalonitrile resins is without doubt the synthesis of low-melting-point monomer coupled with self-catalysed systems. Of these self-catalysed systems, polybenzoxazines derived from phthalonitriles have been implemented, as described in WO 2017/105890. The polymers obtained have advantageous performances with Td_{5%}>450° C. and carbon yields of around 70%.

Moreover, it has been envisaged to use, as starting reagents, a mixture comprising a novolac compound and a phthalonitrile compound, the latter reacting with all or some of the aromatic —OH units of the novolac compound, as described in J. Applied. Polym. Sci. 2012, 125(1), 649-656. However, these resins require the use of formaldehyde, in particular, to form the novolac compound, which can cause health problems for the operator. The curing (or crosslinking) of the resin is self-catalysed by the non-substituted aromatic hydroxyls, and it has particularly been demonstrated that, the greater the number of aromatic hydroxyl units, the lower the polymerisation temperature, whereas increasing the proportion of phthalonitrile compound increases the polymerisation temperature.

In the light of the prior art and the drawbacks mentioned above, the authors of the present invention set themselves the objective of providing novel thermoset materials obtained from a resin, the curing whereof is self-catalysed, the starting reagents whereof are low-molecular-weight monomers (compared to novolac or bisphenol type monomers) and which is presented, before curing, in a liquid form at ambient temperature or a glassy solid with a low melting point, said thermoset material being resistant to high temperature and having a carbon yield greater than 60% after pyrolysis above 950° C. and a 5% degradation temperature greater than 400° C.

### DISCLOSURE OF THE INVENTION

Thus, the invention relates to a thermoset material obtained from the curing by heat treatment of a resin that can be obtained by polycondensation, in a basic medium, of at least one phthalonitrile compound bearing on the benzene ring thereof at least one hydroxyl group.

The resin used for the thermoset materials according to the invention has the following advantages:
the starting reagent (in this instance, the aforementioned phthalonitrile compound) is a low-molecular-weight reagent (compared to those used in the prior art, such as bisphenol reagents);
the presence of at least one hydroxyl group on the phthalonitrile compound acts as a catalyst during the subsequent curing (or crosslinking) of the resin to make it a thermoset material resistant to high temperatures;
the use, as starting reagent, of a phthalonitrile compound provides, after curing the resin, excellent mechanical properties.

The thermoset materials according to the invention are materials resistant to high temperatures and, in particular, have a carbon yield greater than 60% after pyrolysis above 950° C. and a 5% degradation temperature greater than 400° C.

As mentioned above, the resins can be obtained by polycondensation of at least one phthalonitrile compound bearing, on its benzene ring, at least one hydroxyl group.

The phthalonitrile compound is, conventionally, a compound consisting of a benzene ring bearing two nitrile groups at ortho position in relation to each other, this ring being within the scope of the invention, also bearing at least one hydroxyl group, the hydroxyl group(s) being, preferably at ortho position in relation to one of the nitrile groups, where applicable, the other free carbon(s) of this ring not bonded to the hydroxyl group(s) or to the two nitrile groups being optionally bonded to a substituent chosen from a phenyl group, a phenyl group bearing a —CHO group, an —O-phenyl group, an —O-phenyl group bearing a —CHO group. In other words, further comprises, on the benzene ring thereof, one or more substituents chosen from a phenyl group, a phenyl group bearing a —CHO group, an —O-phenyl group or an —O-phenyl group bearing a —CHO group.

More specifically, the phthalonitrile compound can comprise on the benzene ring thereof, two —OH groups, advantageously with no other substituent (apart from, obviously, the two nitrile groups of the phthalonitrile compound) or can comprise, on the benzene ring thereof, a single —OH group and an —O-phenyl group bearing a —CHO group, advantageously with no other substituent (apart from, obviously, the two nitrile groups of the phthalonitrile compound), the —OH group and the —O-phenyl group bearing a —CHO group being, for example, at para position in relation to each other.

In particular, the phthalonitrile compound can comply with the following formula (I):

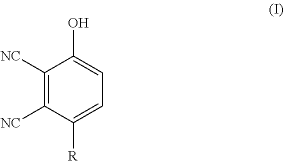

wherein R represents H, —OH, a phenyl group, a phenyl group bearing a —CHO group, an —O-phenyl group or an —O-phenyl group bearing a —CHO group, and preferably, R represents —OH, a phenyl group bearing a —CHO group or an —O-phenyl group bearing a —CHO group.

More specifically, the phthalonitrile compound can be a compound, wherein R is an —OH group, in which case it complies with the following formula (II):

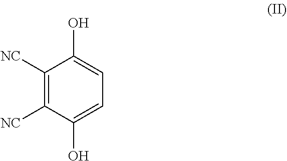 [SMILES: N#Cc1c(O)ccc(O)c1C#N]

this compound also being called 2,3-dicyanohydroquinone.

The phthalonitrile compound can also be a compound, wherein R represents an O-phenyl group bearing a —CHO group, in which case it complies with the following formula (III):

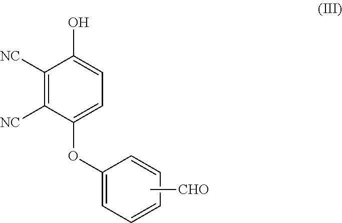

the —CHO group occupying one of the free carbon atoms of the benzene ring, with preferably, this —CHO group occupying the para position, whereby it complies with the following formula (IV):

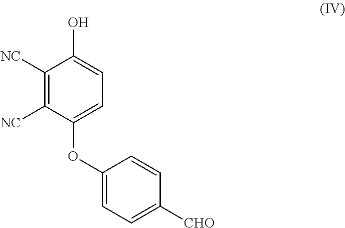 [SMILES: N#Cc1c(O)ccc(Oc2ccc(C=O)cc2)c1C#N]

this compound being called 3-(4-formylphenoxy)-6-hydroxyphthalo nitrile.

According to a first embodiment, the resins according to the invention can, advantageously, be obtained by polycondensation of a single phthalonitrile compound as defined above, the resins comprising, thus, condensates of the single phthalonitrile compound and, more specifically:

when the phthalonitrile compound comprises, on the benzene ring thereof, two —OH groups, advantageously with no other substituent on said ring, such as the compound of formula (II) defined above; or

when the phthalonitrile compound comprises, on the benzene ring thereof, besides an —OH group, a phenyl group bearing a —CHO group or an —O-phenyl group bearing a —CHO group, advantageously, with no other substituent on said ring, such as the compound of formula (III) or (IV) as defined above.

Advantageous resins according to the invention and fulfilling the specificities of the first embodiment are resins resulting from polycondensation, in basic medium, of the compound of formula (II) above or the compound of formula (IV) above.

According to a second embodiment, the resins according to the invention can be obtained by polycondensation of a phthalonitrile compound as defined above and at least one other compound, which can be:

according to a first variant, a benzene ring bearing no —CN group(s) comprising, on the benzene ring thereof, at least one —OH group and optionally comprising, on the benzene ring thereof, one or more substituents, such as an amine group, an alkylene group bearing a hydroxyl group, this first variant being particularly suitable, when the phthalonitrile compound comprises, on the benzene ring thereof, a phenyl group bearing a —CHO group or an —O-phenyl group bearing a —CHO group, advantageously, with no other substituent on said ring (apart from, obviously the nitrile groups or the hydroxyl group(s) of the phthalonitrile group), such as the compound of formula (III) or (IV) as defined above;
according to a second variant, a benzene compound comprising, on the benzene ring thereof, at least one —CHO group and, optionally, comprising, on the benzene ring thereof, one or more substituents, such as a —CN group, a phenyl group, a phenyl group bearing a —CHO group, an —O-phenyl group or an —O-phenyl group bearing a —CHO group, this second variant being particularly suitable, when the phthalonitrile compound comprises, on the benzene ring thereof, two —OH groups, advantageously with no other substituent on said ring (apart from, obviously, the two nitrile groups of the phthalonitrile compound), such as the compound of formula (II) defined above.

More specifically, the benzene compound of the first variant defined above can comply with the following formula (V):

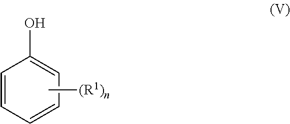

wherein n is an integer ranging from 0 to 5, preferably, ranging from 0 to 2, and, where applicable, the R¹ or R¹s, identical or different, represent(s) an —OH group, an NH₂ group or an alkylene group bearing a hydroxyl group.

For clarification, when n is equal to 0, this means that the benzene compound is not substituted, apart from the —OH group present on the formula (in other words, the benzene compound thus corresponds to phenol). When n is an integer ranging from 1 to 5, this means that the benzene compound is, in addition to the —OH group, substituted by 1 to 5 substituents chosen from the —OH, NH₂ or alkylene groups bearing a hydroxyl group.

Advantageous benzene compounds fulfilling the specificities of the first variant are phenol, resorcinol, phloroglycinol (or benzene-1,3,5-triol), 2-hydroxymethylphenol.

Advantageous resins fulfilling the specificities of the first variant of the second embodiment are resins resulting from polycondensation, in basic medium, of the phthalonitrile compound of formula (IV) defined above and the compound of formula (V) defined above, such as phenol, resorcinol, phloroglucinol, 2-hydromethyl-phenol, it being possible to represent the obtaining of these resins schematically with the following reaction scheme:

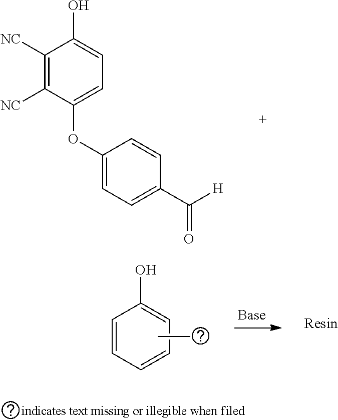

With regard to the second variant, the benzene compound defined above can comply with the following formula (VI):

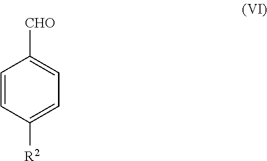

wherein R² represents —CHO, —CN, a phenyl group, a phenyl group bearing a —CHO group, an —O-phenyl group or an —O-phenyl group bearing a —CHO group and, advantageously, —CHO or an —O-phenyl group bearing a —CHO group.

Advantageous benzene compounds fulfilling the specificities of the second variant are terephthalaldehyde or 4,4′-oxydibenzaldehyde of the following respective formulas (VII) and (VIII):

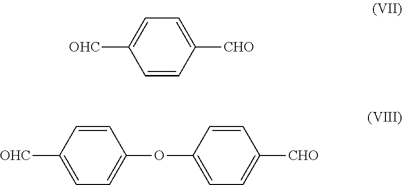 [SMILES: O=Cc1ccc(C=O)cc1 ; O=Cc1ccc(Oc2ccc(C=O)cc2)cc1]

Advantageous resins fulfilling the specificities of the second variant of the second embodiment are resins resulting from polycondensation, in basic medium, of the phthalonitrile compound of formula (II) defined above and the compound of formula (VI) defined above (in particular, the compound of formula (VII) or formula (VIII) defined above), it being possible to represent the obtaining of these resins schematically with the following reaction scheme:

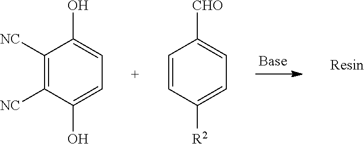

R² being as defined above.

In particular, the resins can be resins obtained exclusively by polycondensation of one or more phthalonitrile compounds as defined above and optionally one or more compounds as defined above (i.e. with no other ingredient involved in the polycondensation reaction per se).

The method for obtaining a thermoset material according to the invention comprises, conventionally, a step of curing the resin according to the invention by heating it to a curing temperature, for example, a temperature ranging from 150° C. to 350° C., for example, a temperature of 350° C., the heat treatment taking place, preferably, in an inert atmosphere, such as an N₂ atmosphere, said temperature being capable of being attained during one or more heating cycles.

Among the resins used for the thermoset materials according to the invention, some are novel and form subject matter of the invention, these resins being resins that can be obtained by polycondensation, in basic medium, of:

at least one phthalonitrile compound bearing, on the benzene ring thereof, at least one hydroxyl group and at least one other compound, which is a benzene compound bearing no —CN group(s) comprising, on the benzene ring thereof, at least one —OH group and optionally comprising, on the benzene ring thereof, one or more substituents chosen from an amine group or an alkylene group bearing a hydroxyl group; or

a single phthalonitrile compound bearing, on the benzene ring thereof, at least one hydroxyl group and further comprising, on the benzene ring thereof, one or more substituents chosen from a phenyl group, a phenyl group bearing a —CHO group, an —O-phenyl group or an —O-phenyl group bearing a —CHO group.

The features mentioned for the resins used in the thermoset materials according to the invention can be repeated here, once they are valid for these resins per se.

The invention also relates to a method for manufacturing a resin according to the invention comprising a step of contacting at least one phthalonitrile compound as defined above with at least one base followed by a step of heating to a suitable temperature to obtain the polycondensation of said at least one phthalonitrile compound.

The specificities of the phthalonitrile compound described above with regard to the resins according to the invention (defined as resins that can be obtained by a method) are also valid for the method according to the invention.

More specifically, the base(s) used within the scope of the method according to the invention can be an organic base and, particularly, an organic base comprising an amine group, such as triethylamine, or an amidine group, such as 1,8-diazabicyclo[5.4.0]undec-7-ene of the following formula (IX):

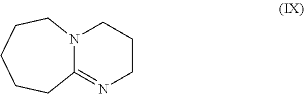 [SMILES: C1CCC2=NCCCN2CC1]

The base(s) is (are), preferably, present at a content ranging from 5 to 100% molar in relation to the number of moles of phthalonitrile compound(s) initially present (i.e. before the polycondensation reaction has started).

More specifically, the base(s) can be present at a rate of 50 to 100% molar in relation to the number of moles of phthalonitrile compound(s) initially present (i.e. before the polycondensation reaction has started) and, even more specifically, can be present at a rate of 50%.

The suitable temperature for obtaining polycondensation of the phthalonitrile compound(s) and, where applicable, the other compound(s) defined hereinafter, can be set, advantageously, to a value greater than or equal to 80° C. and, more specifically, can range from 80° C. to 130° C., it being possible to maintain the temperature for a period of at least one hour and, more specifically, of 1 hour to 24 hours.

Before contacting with the base(s), the phthalonitrile compound(s) can be solubilised in an organic solvent, for example, an alcoholic solvent, such as ethanol, a nitrile solvent, such as acetonitrile or a sulfoxide solvent such as dimethyl sulfoxide, the choice of solvent depending, obviously, on the phthalonitrile compound(s) used in the method according to the invention.

Furthermore, according to the sought resin, it is possible to add, in addition to the phthalonitrile compound and the base, before the heating step, at least one other compound, such as:

according to a first variant, a benzene compound bearing no —CN group(s) comprising, on the benzene ring thereof, at least one —OH group and optionally comprising, on the benzene ring thereof, one or more substituents, such as an amine group or an alkylene group bearing a hydroxyl group, this first variant being particularly suitable, when the phthalonitrile compound comprises, on the benzene ring thereof, a phenyl group bearing a —CHO group or an —O-phenyl group bearing a —CHO group, advantageously, with no other substituent on said ring (apart from, obviously the nitrile groups and the hydroxyl group(s) of the phthalonitrile compound), such as the compound of formula (III) or (IV) as defined above;

according to a second variant, a benzene compound comprising, on the benzene ring thereof, at least one —CHO group and, optionally, comprising on the benzene ring thereof, one or more substituents, such as a —CN group, a phenyl group, a phenyl group bearing a —CHO group, an —O-phenyl group or an —O-phenyl group bearing a —CHO group, this second variant being particularly suitable, when the phthalonitrile compound comprises, on the benzene ring thereof, two —OH groups, advantageously with no other substituent on said ring (apart from, obviously, the two nitrile groups of the phthalonitrile compound), such as the compound of formula (II) defined above,
this addition being performed before the step of heating to the suitable temperature to obtain polycondensation of the phthalonitrile compound(s) and the other compound(s) as defined above.

The specific examples of compounds of the first variant and the second variant provided above in the descriptive part of the resins per se are also valid for the descriptive part of the method per se.

According to the other compound(s) used, this addition can be performed after the phthalonitrile compound(s) and the base(s) have been contacted (which can be the case, for example, when the phthalonitrile compound complies with the formula (II) and the other compound complies with the general formula (VI)), can be performed simultaneously with the contacting with the base(s) (which is the case, for example, when the phthalonitrile compound complies with the general formula (III) and the other compound is phenol, resorcinol, phloroglucinol) or can be performed with the phthalonitrile compound(s) to form a mixture, to which the base(s) is (are) added (which is the case, for example, when the phthalonitrile compound complies with the general formula (III) and the other compound is 2-hydroxymethylphenol or 2-aminophenol).

According to the nature of the other compound, there may be a heating operation intended to melt it before the contacting thereof with the phthalonitrile compound(s) and the base(s) or a reflux heating operation of the other compound with the phthalonitrile compound(s), so as to obtain a homogeneous mixture.

More specifically, the contacting step and the heating step are carried out in the sole presence of one or more phthalonitrile compound(s) as defined above, optionally one or more other compounds as defined above, one or more organic solvents and one or more bases as defined above (which means, in other words, that it requires no other ingredients).

The other compound(s), when they are present, can be used according to a molar ratio (other compound(s)/phthalonitrile compound(s)) ranging from 0.25 to 1.

After the heating step of the method according to the invention, the temperature is brought back, conventionally to ambient temperature.

After the heating step of the method according to the invention and once brought back to ambient temperature, the method according to the invention can comprise a step of distilling the resin, this distillation particularly making it possible to remove the organic solvent(s).

Among the other compound(s) mentioned above and suitable for use within the scope of the invention, some are novel and form subject matter of the invention, these compounds being intermediate compounds useful for the manufacture of a resin according to the invention and complying with the following formula (III):

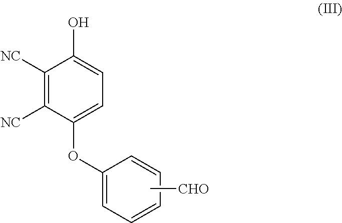

the —CHO group occupying one of the free carbon atoms of the phenyl group, a specific example being the compound for which the —CHO group occupies the para position, this compound complying with the following formula (IV):

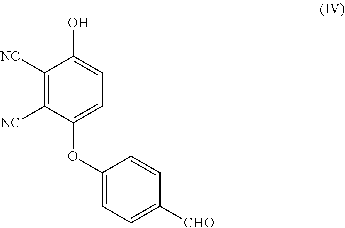 [SMILES: N#Cc1c(O)ccc(Oc2ccc(C=O)cc2)c1C#N]

this compound being called 3-(4-formylphenoxy)-6-hydroxyphthalonitrile.

The compounds of formula (IV) can be obtained with a method comprising a step of reacting, in basic medium (for example, potassium carbonate), 2,3-dicyanohydroquinone with a benzene compound bearing a —CHO group and a nucleofuge group, for example, a halogen atom (and more specifically, a fluorine atom), this reaction being an aromatic nucleophilic substitution reaction that can be represented by the following reaction scheme:

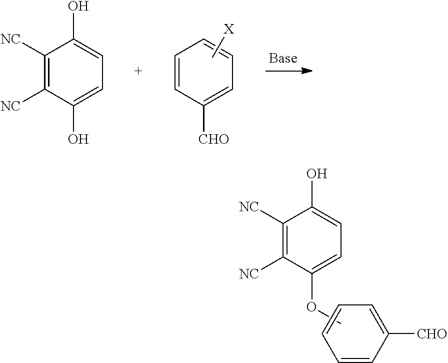

X represents a nucleofuge group.

After the method according to the invention, the resin obtained is a resin comprising condensates of phthalonitrile compound(s) and, where applicable, condensates of phthalonitrile compound(s) and other compound(s) as defined above.

The invention also relates to a composite material consisting of a matrix of a thermoset material as defined above, said matrix trapping one or more fillers.

The method for obtaining a composite material according to the invention comprises, conventionally, the following successive steps:
a step of adding one or more fillers to the suitable resin;
a step of curing the resin comprising one or more fillers by heating it to a curing temperature, for example a temperature ranging from 150° C. to 350° C., for example, a temperature of 350° C., resulting in a composite material comprising a matrix resulting from the curing of the resin and the filler(s) dispersed in the matrix, said temperature can be attained during one or more heating cycles.

Further features and advantages of the invention will become apparent from the following supplementary description with reference to specific embodiments.

Obviously, this supplementary description is merely given by way of illustration of the invention and is no way a restriction.

### DETAILED DESCRIPTION OF SPECIFIC EMBODIMENTS

### Example 1

This example illustrates the preparation of a resin obtained from polycondensation of a phthalonitrile compound of the following formula (II):

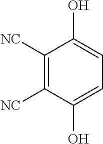 [SMILES: N#Cc1c(O)ccc(O)c1C#N]

corresponding to 2,3-dicyanohydroquinone (symbolised, in this and the following examples, by the abbreviation 2,3-DCNHQ), polycondensation being implemented in basic medium with the use of 1,8-diazabicyclo[5.4.0]undec-7-ene (symbolised, in this and the following examples, by the abbreviation DBU).

For this purpose, in a 50 mL single-neck round-bottom flask, 2,3-DCNHQ. (1.63 g; 0.01 mol) is presolubilised in acetonitrile (10 mL) then DBU (0.76 g; 0.005 mol) is added. The resulting mixture is stirred mechanically and heated to 90° C. for 24 hours. The mixture is then brought back to ambient temperature then distilled in a vacuum at 40° C., until a brown resin is obtained (3.51 g).

### Example 2

This example illustrates the preparation of a resin obtained from polycondensation of the phthalonitrile compound 2,3-DCNHQ, the polycondensation being implemented in basic medium with the use of triethylamine (Et₃N).

For this purpose, in a 50 mL single-neck round-bottom flask, 2,3-DCNHQ (1.63 g; 0.01 mol) is presolubilised in acetonitrile (10 mL) then triethylamine (0.51 g; 0.005 mol) is added. The resulting mixture is stirred mechanically and heated to 90° C. for 24 hours. The mixture is then brought back to ambient temperature then distilled in a vacuum at 40° C., until a meltable black solid (2.48 g) having a melting point of 170° C. is obtained.

### Example 3

This example illustrates the preparation of a resin obtained from polycondensation of the phthalonitrile compound 2,3-DCNHQ and terephthalaldehyde, the polycondensation being implemented in basic medium with the use of DBU.

For this purpose, in a 50 mL single-neck round-bottom flask, 2,3-DCNHQ (1.63 g; 0.01 mol) is presolubilised in acetonitrile (10 mL) then DBU (0.76 g; 0.005 mol) is added. Once the homogeneous mixture is obtained, terephthalaldehyde (0.67 g; 0.005 mol) is added. The resulting mixture is stirred mechanically and heated to 90° C. for 24 hours. The mixture is then brought back to ambient temperature then distilled in a vacuum at 40° C., until an orange resin (2.96 g) is obtained.

### Example 4

This example illustrates the preparation of a resin obtained from polycondensation of the phthalonitrile compound 2,3-DCNHQ and terephthalaldehyde, the polycondensation being implemented in basic medium with the use of triethylamine.

For this purpose, in a 50 mL single-neck round-bottom flask, 2,3-DCNHQ (1.63 g; 0.01 mol) is presolubilised in acetonitrile (10 mL) then triethylamine (0.51 g; 0.005 mol) is added. Once the homogeneous mixture is obtained, terephthalaldehyde (0.67 g; 0.005 mol) is added. The resulting mixture is stirred mechanically and heated to 90° C. for 24 hours. The mixture is then brought back to ambient temperature then distilled in a vacuum at 40° C., until a brown resin (2.96 g) is obtained.

### Example 5

This example illustrates the preparation of a resin obtained from polycondensation of the phthalonitrile compound 2,3-DCNHQ and 4,4′-oxydibenzaldehyde, the polycondensation being implemented in basic medium with the use of DBU.

For this purpose, in a 50 mL single-neck round-bottom flask, 2,3-DCNHQ (1.63 g; 0.01 mol) is presolubilised in acetonitrile (10 mL) then DBU (0.76 g; 0.005 mol) is added. Once the homogeneous mixture is obtained, 4,4′-oxydibenzaldehyde (1.18 g; 0.005 mol) is added. The resulting mixture is stirred mechanically and heated to 90° C. for 24 hours. The mixture is then brought back to ambient temperature then distilled in a vacuum at 40° C., until a brown resin (4.51 g) is obtained.

### Example 6

This example illustrates the preparation of a resin obtained from polycondensation of the phthalonitrile compound 2,3-DCNHQ and 4,4′-oxydibenzaldehyde, the polycondensation being implemented in basic medium with the use of triethylamine.

For this purpose, in a 50 mL single-neck round-bottom flask, 2,3-DCNHQ (1.63 g; 0.01 mol) is presolubilised in acetonitrile (10 mL) then triethylamine (0.51 g; 0.005 mol) is added. Once the homogeneous mixture is obtained, 4,4′-oxydibenzaldehyde (1.18 g; 0.005 mol) is added. The resulting mixture is stirred mechanically and heated to 90° C. for 24 hours. The mixture is then brought back to ambient temperature then distilled in a vacuum at 40° C., until a brown resin (4.20 g) is obtained.

### Comparative Example 1

This example is an example not according to the invention illustrating the preparation of a resin obtained from polycondensation of hydroquinone, terephthalaldehyde, the polycondensation being implemented in basic medium with the use of DBU.

For this purpose, in a 50 mL single-neck round-bottom flask, hydroquinone (1.12 g; 0.01 mol) is presolubilised in acetonitrile (10 mL) then DBU (0.76 g; 0.005 mol) is added. Once the homogeneous mixture is obtained, terephthalaldehyde (0.67 g; 0.005 mol) is added. The resulting mixture is stirred mechanically and heated to 90° C. for 24 hours. The mixture is then brought back to ambient temperature then distilled in a vacuum at 40° C., until a black resin (3.73 g) is obtained.

### Comparative Example 2

This example is an example not according to the invention illustrating the preparation of a resin obtained from polycondensation of hydroquinone, terephthalaldehyde, the polycondensation being implemented in basic medium with the use of triethylamine.

For this purpose, in a 50 mL single-neck round-bottom flask, hydroquinone (1.12 g; 0.01 mol) is presolubilised in acetonitrile (10 mL) then triethylamine (0.51 g; 0.005 mol) is added. Once the homogeneous mixture is obtained, terephthalaldehyde (0.67 g; 0.005 mol) is added. The resulting mixture is stirred mechanically and heated to 90° C. for 24 hours. The mixture is then brought back to ambient temperature then distilled in a vacuum at 40° C., until a black resin (5.92 g) is obtained.

### Example 7

This example illustrates the preparation of an intermediate product for the preparation of a resin according to the invention, this intermediate product complying with the following formula (IV):

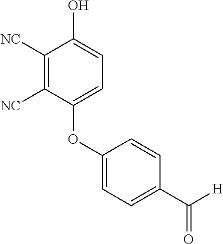 [SMILES: N#Cc1c(O)ccc(Oc2ccc(C=O)cc2)c1C#N]

this intermediate product corresponding to 3-(4-formylphenoxy)-6-hydroxyphthalonitrile and being symbolised, hereinafter, by FPHP, in this example and the following examples.

For this purpose, into a 250 mL single-neck round-bottom flask under nitrogen, 2,3-dicyanohydroquinone (8.60 g; 0.053 mol), dimethyl sulfoxide DMSO (50 mL) and 4-fluorobenzaldehyde (7.99 g; 0.063 mol) are introduced. The mixture is stirred and, once homogeneous, potassium carbonate (21.81 g; 0.158 mol) is added, then the medium is heated to 110° C. for 4 hours. At the end of the reaction, the heating is stopped and the mixture is distilled in a vacuum at 75° C. and 5 mbar, in order to remove the excess of 4-fluorobenzaldehyde and a portion of the DMSO. The residue is transferred into an Erlenmeyer and 500 mL of water is added and the pH is brought back to approximately 5 using an HCl (1 M) solution. Then, the organic phase is extracted 3 times with ethyl acetate then the organic phases are collected, dried on MgSO₄, filtered and concentrated in a vacuum. The powder obtained is then kept for 12 hours at 50° C. and in a vacuum of 1 mBar. 3-(4-formylphenoxy)-6-hydroxyphthalonitrile is then obtained (m=11.94 g; yield=85%). The product is used as is with no additional purification.

### Example 8

The present example illustrates the preparation of a resin obtained from polycondensation of the FPHP compound prepared in example 7 above, the polycondensation being implemented in basic medium with the use of DBU.

For this purpose, in a 50 mL single-neck round-bottom flask, FPHP (0.81 g; 0.003 mol) is presolubilised in acetonitrile (10 mL) then DBU (0.23 g; 0.0015 mol) is added. The resulting mixture is stirred mechanically and heated to 90° C. for 24 hours. The mixture is then brought back to ambient temperature then distilled in a vacuum at 40° C., until a black resin (3.73 g) is obtained.

### Example 9

The present example illustrates the preparation of a resin obtained from polycondensation of the FPHP compound prepared in example 7 above, the polycondensation being implemented in basic medium with the use of triethylamine.

For this purpose, in a 50 mL single-neck round-bottom flask, FPHP (1.07 g; 0.004 mol) is presolubilised in acetonitrile (10 mL) then triethylamine (0.20 g; 0.002 mol) is added. The resulting mixture is stirred mechanically and heated to 90° C. for 24 hours. The mixture is then brought back to ambient temperature then distilled in a vacuum at 40° C., until an orange resin (1.69 g) is obtained with formation of a precipitate at ambient temperature but which is resorbed during heating.

### Example 10

The present example illustrates the preparation of a resin obtained from polycondensation of the FPHP compound prepared in example 7 above with phenol, the polycondensation being implemented in basic medium with the use of triethylamine.

For this purpose, in a 50 mL single-neck round-bottom flask, FPHP (1.20 g; 0.0045 mol) is presolubilised in acetonitrile (10 mL) then phenol (0.285 g; 0.003 mol) and triethylamine (0.152 g; 0.0015 mol) are added. The resulting mixture is stirred mechanically and heated to 90° C. for 24 hours. The mixture is then brought back to ambient temperature then distilled in a vacuum at 40° C., until a yellow resin (2.94 g) is obtained.

### Example 11

The present example illustrates the preparation of a resin obtained from polycondensation of the FPHP compound prepared in example 7 above with resorcinol, the polycondensation being implemented in basic medium with the use of triethylamine.

For this purpose, in a 50 mL single-neck round-bottom flask, FPHP (1.20 g; 0.0045 mol) is presolubilised in acetonitrile (10 mL) then resorcinol (0.330 g; 0.003 mol) and triethylamine (0.152 g; 0.0015 mol) are added. The resulting mixture is stirred mechanically and heated to 90° C. for 24 hours. The mixture is then brought back to ambient temperature then distilled in a vacuum at 40° C., until an orange resin (2.76 g) is obtained.

### Example 12

The present example illustrates the preparation of a resin obtained from polycondensation of the FPHP compound prepared in example 7 above with phloroglucinol, the polycondensation being implemented in basic medium with the use of triethylamine.

For this purpose, in a 50 mL single-neck round-bottom flask, FPHP (1.20 g; 0.0045 mol) is presolubilised in acetonitrile (10 mL) then phloroglucinol (0.382 g; 0.003 mol) and triethylamine (0.152 g; 0.0015 mol) are added. The resulting mixture is stirred mechanically and heated to 90° C. for 24 hours. The mixture is then brought back to ambient temperature and a brown glassy solid (2.81 g) is obtained.

### Example 13

The present example illustrates the preparation of a resin obtained from polycondensation of the FPHP compound prepared in example 7 above with 2-hydroxymethylphenol (2-HMP), the polycondensation being implemented in basic medium with the use of DBU.

For this purpose, in a 50 mL single-neck round-bottom flask, 2-HMP (0.627 g; 0.005 mol) is melted at 130° C. then FPHP (1.34 g; 0.005 mol) is introduced with a very small quantity of ethanol to obtain a homogeneous medium. Finally, DBU (0.038 g; 0.25 mmol) is added and the medium kept for 30 minutes at 130° C. under mechanical stirring and without coolant. A brown resin (3.71 g) is then retrieved.

### Example 14

The present example illustrates the preparation of a resin obtained from polycondensation of the FPHP compound prepared in example 7 above with 2-aminophenol, the polycondensation being implemented in basic medium with the use of triethylamine.

For this purpose, in a 50 mL single-neck round-bottom flask, FPHP (1.34 g; 0.005 mol), 2-aminophenol (0.55 g; 0.005 mol) and ethanol (10 mL) are introduced. The medium is heated to reflux for 1 hour then triethylamine (0.256 g; 2.5 mmol) is added and the heating continued for 24 hours. The heating is then stopped, the medium brought back to ambient temperature and distilled in a vacuum at 40° C. until a red resin (3.82 g) is obtained.

### Example 15

The resins obtained in the preceding examples underwent curing by heat treatment in an inert atmosphere, the heat treatment comprising the succession of two cycles until the temperature of 350° C. was reached, the first cycle comprising the following operations: 40 hours at 65° C.; 40 hours at 80° C.; 21 hours at 95° C.; 8 hours at 120° C.; 5 hours at 150° C. and 36 hours at 175° C. and the second cycle comprising the following operations: 1 hour at 200° C.; 1 hour at 250° C.; 1 hour at 300° C. and 1 hour at 350° C.

The products obtained at the end of the first cycle and the second cycle were analysed bythermogravimetric analysis carried out using the TGA-Q500 apparatus supplied by TA Instruments, the analysis consisting of a ramp in argon at 20° C./minute up to 1000° C., the residue obtained at the end of this treatment being qualified by the carbon yield (% C) and the temperature at 5% mass degradation (Td₅%).

Table 1 below illustrates the results for the product obtained at the end of the first cycle.

TABLE 1

| Example | % C (%) | Td_{5%} (° C.) |
|---|---|---|
| 1 | 58 | 284 |
| 2 | 59 | 237 |
| 3 | 52 | 255 |
| 4 | 46 | 241 |
| 5 | 58 | 295 |
| 6 | 64 | 288 |
| Comparative 1 | 35 | 273 |
| Comparative 2 | 36 | 248 |
| 8 | 53 | 303 |
| 9 | 67 | 389 |
| 10 | 66 | 355 |
| 11 | 58 | 302 |
| 12 | 63 | 307 |
| 13 | 60 | 343 |
| 14 | 54 | 271 |

Table 2 below illustrates the results for the product obtained at the end of the second cycle.

TABLE 2

| Example | % C (%) | Td_{5%} (° C.) |
|---|---|---|
| 1 | 71 | 401 |
| 2 | 62 | 425 |
| 3 | 72 | 425 |
| 4 | 71 | 440 |
| 5 | 72 | 456 |
| 6 | 70 | 433 |
| 7 | 63 | 401 |
| 8 | 74 | 486 |
| 9 | 69 | 457 |
| 10 | 73 | 459 |
| 11 | 70 | 430 |
| 12 | 70 | 428 |
| 13 | 62 | 426 |
| 14 | 66 | 450 |

The FHPH from example 7 was not characterised by the cycle up to 175° C., because this cycle has temperatures below the melting point thereof which is around 220° C.

The comparative resins of comparative example 1 and comparative example 2 were not cured at 350° C. because, by DSC, no residual exotherm is observed after the cycle up to 175° C. Moreover, at 350° C., they start to degrade, which shows that inserting phthalonitrile units makes it possible to increase, in particular, the thermal stability of the material.

Moreover, it appears that the thermoset materials up to 350° C. from the resins according to the invention have a carbon yield greater than 60% after pyrolysis above 950° C. and a 5% degradation temperature greater than 400° C., which demonstrates materials resistant to high temperatures.

What is claimed is:

1. A thermoset material obtained from a curing by heat treatment of a resin that can be obtained by polycondensation, in a basic medium, of at least one phthalonitrile compound bearing, on the benzene ring thereof, at least one hydroxyl group.

2. The thermoset material of claim 1, wherein the hydroxyl group(s) is (are) at ortho position in relation to one of the nitrile groups.

3. The thermoset material of claim 1, wherein the phthalonitrile compound comprises, on the benzene ring thereof:
one or more substituents chosen from a phenyl group, a phenyl group bearing a —CHO group, an —O-phenyl group and an —O-phenyl group bearing a —CHO group; and/or
two —OH groups, or one —OH group and an —O-phenyl group bearing a —CHO group.

4. (canceled)

5. (canceled)

6. The thermoset material of claim 1, wherein the phthalonitrile compound has formula (I): 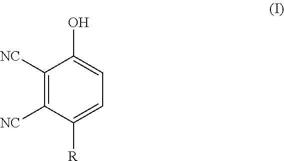
wherein R is H, —OH, a phenyl group, a phenyl group bearing a —CHO group, an —O-phenyl group or an —O-phenyl group bearing a —CHO group.

7. The thermoset material of claim 1, wherein the phthalonitrile compound has formula (II) or formula (III):

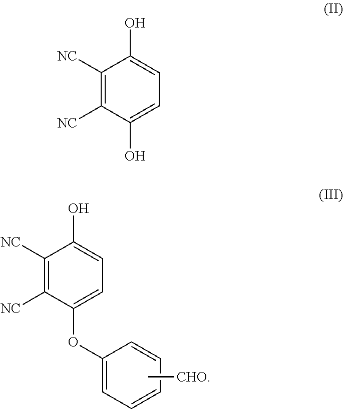

8. (canceled)

9. The thermoset material of claim 7, wherein the phthalonitrile compound has formula (IV):

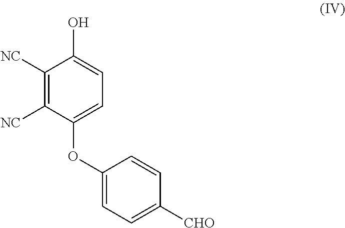 [SMILES: N#Cc1c(O)ccc(Oc2ccc(C=O)cc2)c1C#N]

10. (canceled)

11. (canceled)

12. The thermoset material of claim 1, wherein the resin is obtained by polycondensation of a phthalonitrile compound and at least one other compound, which is a benzene compound bearing no —CN group(s), the benzene compound comprising, on the benzene ring thereof, at least one —OH group and optionally one or more substituents chosen from an amine group and an alkylene group bearing a hydroxyl group.

13. The thermoset material of claim 12, wherein the phthalonitrile compound comprises, on the benzene ring thereof, a phenyl group bearing a —CHO group or an —O-phenyl group bearing a —CHO group.

14. The thermoset material of claim 12, wherein the benzene compound has formula (V): 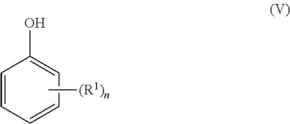
wherein n is an integer ranging from 0 to 5, and, if:
n is equal to 1, R¹ is an —OH group, an NH₂ group or an alkylene group bearing a hydroxyl group, and
n is equal to 2, 3, 4 or 5, each R¹ is selected from an —OH group, an NH₂ group and an alkylene group bearing a hydroxyl group.

15. The thermoset material of claim 12, wherein the benzene compound is phenol, resorcinol, phloroglycinol or 2-hydroxymethylphenol.

16. The thermoset material of claim 1, wherein the resin is obtained by polycondensation of a phthalonitrile compound and at least one other compound, which is a benzene compound comprising, on the benzene ring thereof, at least one —CHO group and, optionally, one or more substituents chosen from a —CN group, a phenyl group, a phenyl group bearing a —CHO group, an —O-phenyl group and an —O-phenyl group bearing a —CHO group.

17. The thermoset material of claim 16, wherein the phthalonitrile compound comprises, on the benzene ring thereof, two —OH groups.

18. The thermoset material of claim 16, wherein the benzene compound has formula (VI): 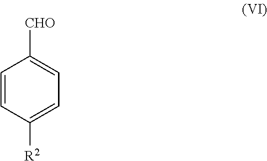
wherein R² is —CHO, —CN, a phenyl group, a phenyl group bearing a —CHO group, an —O-phenyl group or an —O-phenyl group bearing a —CHO group.

19. The thermoset material of claim 16, wherein the benzene compound is terephthalaldehyde or 4,4′-oxydibenzaldehyde.

20. A resin that can be obtained by polycondensation, in basic medium, of:
at least one phthalonitrile compound bearing, on the benzene ring thereof, at least one hydroxyl group and at least one other compound, which is a benzene compound bearing no —CN group(s) comprising, on the benzene ring thereof, at least one —OH group and optionally one or more substituents chosen from an amine group and an alkylene group bearing a hydroxyl group; or
one phthalonitrile compound bearing, on the benzene ring thereof, at least one hydroxyl group and further comprising, on the benzene ring thereof, one or more substituents chosen from a phenyl group, a phenyl group bearing a —CHO group, an —O-phenyl group and an —O-phenyl group bearing a —CHO group.

21. A method for manufacturing a resin as defined in claim 20 comprising the following steps:
a) preparing a mixture by contacting at least one phthalonitrile compound with at least one base;
b) heating the mixture to a suitable temperature to obtain the polycondensation of the at least one phthalonitrile compound;
c) bringing the temperature back to ambient temperature; and then
d) distilling the mixture;
whereby the resin is obtained.

22. (canceled)

23. The method of claim 21, wherein the mixture comprises a content of base(s) ranging from 5 to 100% molar relative to the number of moles of phthalonitrile compound(s).

24. The method of claim 21, wherein step a) further comprises adding to the mixture at least one compound chosen from:
a benzene compound bearing no —CN group(s) comprising, on the benzene ring thereof, at least one —OH group and optionally one or more substituents chosen from an amine group and an alkylene group bearing a hydroxyl group; and
a benzene compound comprising, on the benzene ring thereof, at least one —CHO group and, optionally, one or more substituents chosen from a —CN group, a phenyl group, a phenyl group bearing a —CHO group, an —O-phenyl group and an —O-phenyl group bearing a —CHO group.

25. (canceled)

26. (canceled)

27. (canceled)

28. A composite material consisting of a matrix of a thermoset material as defined in claim 1 and at least one filler within the matrix.

29. The composite material of claim 28, wherein the filler(s) consist of carbon fibres.
